(19) United States
(12) Patent Application Publication
(10) Pub. No.: US 2017/0058809 A1
(43) Pub. Date: Mar. 2, 2017

(54) METHOD AND DEVICE FOR DIAGNOSING LEAK OF FUEL SYSTEM IN VEHICLE

(71) Applicant: Hyundai Motor Company, Seoul (KR)

(72) Inventor: Se Geun Kim, Yongin (KR)

(21) Appl. No.: 14/955,768

(22) Filed: Dec. 1, 2015

(30) Foreign Application Priority Data
Aug. 27, 2015 (KR) 10-2015-0121168

(51) Int. Cl. F02D 41/22; G01M 3/02; F02M 25/08

(52) U.S. Cl. CPC F02D 41/22; F02M 25/0827; G01M 3/025; F02D 2041/225

(57) ABSTRACT

A method for diagnosing a leak of a fuel system in a vehicle is provided. The method includes determining whether an engine is actuated and a vehicle is thus driven as a monitoring condition for diagnosing the leak of the fuel system and determining whether an additional monitoring condition for monitoring an outflow of the fuel system is satisfied in response to determining that the engine is actuated and the internal pressure of a fuel tank included in the fuel system is less than a target value. The additional monitoring condition is a condition of preventing misdiagnosis of the leak in the fuel system due to disturbance while the vehicle is driven.

### CROSS-REFERENCE TO RELATED APPLICATION

This application claims priority to and the benefit of Korean Patent Application No. 10-2015-0121168 filed in the Korean Intellectual Property Office on Aug. 27, 2015, the entire contents of which are incorporated herein by reference.

### BACKGROUND

(a) Field of the Invention

The present invention relates to a technology related to diagnosing a leak of a fuel system, and more particularly, to a method and a device for diagnosing a leak of a fuel system while a vehicle is driven.

(b) Description of the Related Art

In general, a vehicle using an internal combustion engine combusts fuel stored in a fuel tank to generate power. The fuel stored in the fuel tank discharges evaporative gas as time passes even though an amount varies based on a degree of volatility and an exterior temperature. Additionally, a panel for preventing the fuel from being shaken or flowing while driving and multiple devices including a fuel flowmeter, and the like, and a filler pipe configured to receive the fuel from the exterior are installed in the fuel tank of the vehicle, and the fuel filled or stored in the fuel tank through the filler pipe generates fuel evaporative gas as time passes. The fuel evaporative gas is evaporative gas of gasoline which is the fuel in the fuel tank of the vehicle, and when the fuel evaporative gas is emitted to the atmosphere, serious atmospheric pollution may occur.

When the evaporative gas is discharged to the atmosphere, fuel may be wasted and the discharged evaporative gas becomes pollution, and as a result, an evaporative gas system that stores the evaporative gas in a canister and supplies the stored evaporative gas to the engine again is provided in the vehicle.

In recent years, the number of vehicles being manufactured has rapidly increased and exhaust gas discharged from the vehicle has an effect on environmental pollution due to the rapid increase in the number of vehicles. Research is being actively conducted to reduce the amount of the discharge gas of the vehicle to reduce the environmental pollution, and various countries have established vehicle discharge gas restriction regulations (On-Board Diagnostics (OBD)-II). In other words, to detect the leak of the fuel system, which is one of items required for diagnosing failures of the systems, and which influence the increase of the discharge gas of the vehicle, it is determined that an engine controller needs to accurately detect a leak equivalent to sizes of 0.5 mm and 1.0 mm as required in current restriction regulations.

A leak sensing system of a general fuel system generates negative pressure in the fuel tank and measures the magnitude of the leak with a change rate of the generated negative pressure. In other words, the size of a leak hole may be calculated based on the change rate of the pressure in the fuel tank caused by the generation of the fuel evaporative gas and the change rate of the pressure in the fuel tank caused by the negative pressure (alternatively, a vacuum).

In an example of a technology for diagnosing the leak of the fuel tank of the vehicle, the pressure in the fuel tank is reduced while in an idle state in which the vehicle stops, and thereafter, the leak is monitored based on an increase speed of the change rate of the pressure in the fuel tank. When the pressure increase speed is substantial in association therewith, a leak error is determined. In addition, when the pressure increase speed is substantially low, it may be determined that there is no leak.

The above information disclosed in this section is merely for enhancement of understanding of the background of the invention and therefore it may contain information that does not form the prior art that is already known in this country to a person of ordinary skill in the art.

### SUMMARY

The present invention provides a method and a device for diagnosing a leak of a fuel system in a vehicle, which may diagnose a leak of a fuel system while a vehicle such as a hybrid vehicle is being driven.

An exemplary embodiment of the present invention provides a method for diagnosing a leak of a fuel system in a vehicle that may include: determining, by a controller, whether an engine is actuated and a vehicle is thus driven as a monitoring condition for diagnosing the leak of the fuel system; and determining, by the controller, whether an additional monitoring condition for monitoring an outflow of the fuel system is satisfied in response to determining that the engine is actuated and the internal pressure of a fuel tank of the fuel system is less than a target value, wherein the additional monitoring condition includes preventing misdiagnosis of the leak in the fuel system due to disturbance while the vehicle is being driven.

The additional monitoring condition may be a driving condition which does not correspond to a condition in which a rapid acceleration mode and a rapid deceleration mode of the vehicle while driving are repeated, a condition in which the vehicle is driven on a road having a varied slope, or a driving condition based on a rapid operation of a vehicle steering wheel.

The additional monitoring condition may be a condition in which the vehicle repeats braking on and off (e.g., engaging and disengaging a brake pedal) while creep driving, a condition in which the vehicle is driven on an uneven road, or a driving condition which does not correspond to a condition after the vehicle is refueled. The additional monitoring condition may be a driving condition which does not correspond to a condition in which the exterior temperature of the vehicle is greater than a particular temperature, a condition in which the vehicle is driven on an uphill road or a downhill road, or a condition in which the vehicle is driven with fuel having high vapor pressure.

Before the controller determines whether the internal pressure of the fuel tank is less than the target value, the controller may be configured to operate a canister purge valve to open or close a passage that connects a canister collecting evaporative gas of the fuel tank and the engine to be opened and operate a canister close valve to provide or interrupt the atmosphere extraneous to the vehicle to or from a canister to be closed to apply negative pressure of the engine to the fuel tank. When the controller determines the outflow of the fuel system, the controller may be configured to operate the canister purge valve to be closed and operate the canister close valve to be closed.

Another exemplary embodiment of the present invention provides a device for diagnosing a leak of a fuel system in a vehicle that may include: a sensor configured to generate a driving signal by sensing whether an engine is actuated and a vehicle is thus driven as a monitoring condition for diagnosing the leak of the fuel system; and a controller configured to determine that the monitoring condition is satisfied based on the driving signal transmitted from the sensor and determine whether an additional monitoring condition for monitoring an outflow of the fuel system is satisfied in response to determining that the monitoring condition is satisfied and the internal pressure of the fuel tank of the fuel system is less than a target value, wherein the additional monitoring condition includes preventing misdiagnosis of the leak in the fuel system due to disturbance while the vehicle is driven.

The additional monitoring condition may be a driving condition which does not correspond to a condition in which a rapid acceleration mode and a rapid deceleration mode of the vehicle while driving are repeated, a condition in which the vehicle is driven on a road having a varied slope, or a driving condition based on a rapid operation of a vehicle steering wheel. The additional monitoring condition may be a condition in which the vehicle repeats braking on and off while creep driving, a condition in which the vehicle is driven on an uneven road, or a driving condition which does not correspond to a condition after the vehicle is refueled.

The additional monitoring condition may be a driving condition which does not correspond to a condition in which the exterior temperature of the vehicle is greater than a particular temperature, a condition in which the vehicle is driven on an uphill road or a downhill road, or a condition in which the vehicle is driven with fuel having high Reid vapor pressure. Before the controller determines whether the internal pressure of the fuel tank is less than the target value, the controller may be configured to operate a canister purge valve to open or close a passage that connects a canister collecting evaporative gas of the fuel tank and the engine to be opened and operate a canister close valve to provide or interrupt the atmosphere extraneous to the vehicle to or from the canister to be closed to apply negative pressure of the engine to the fuel tank. When the controller determines the outflow of the fuel system, the controller may be configured to operate the canister purge valve to be closed and operate the canister close valve to be closed.

According to exemplary embodiments of the present invention, a method and a device for diagnosing a leak of a fuel system in a vehicle may prevent cost from being increased to cope with on board diagnostics (OBD) regulations in a fuel efficiency technology applied vehicle such as an idle stop & go (ISG) function or a hybrid (alternatively, hybrid power) vehicle. Accordingly, in the present invention, it may possible to cope (deal) with various OBD IN-USE regulations related to discharge gas regulations of an in-use vehicle of an on-board diagnostics rule.

### BRIEF DESCRIPTION OF THE DRAWINGS

A brief description of each drawing is provided to more sufficiently understand drawings used in the detailed description of the present invention.

FIG. 1 is a flowchart illustrating an example of a method for diagnosing a leak of a fuel system according to the related art;

FIG. 2 is a flowchart illustrating the method for diagnosing the leak of the fuel system after a step of monitoring an outflow of FIG. 1 according to the related art;

FIG. 3 is a flowchart illustrating a method for diagnosing a leak of a fuel system in a vehicle according to an exemplary embodiment of the present invention;

FIG. 4 is a flowchart illustrating the method for diagnosing the leak of the fuel system after a step of monitoring an outflow of FIG. 3 according to an exemplary embodiment of the present invention;

FIG. 5 is a table for describing the additional monitoring condition illustrated in FIG. 4 according to an exemplary embodiment of the present invention;

FIG. 6 is a timing diagram for describing the method for diagnosing the leak of the fuel system in the vehicle, which is illustrated in FIGS. 3, 4, and 5 according to an exemplary embodiment of the present invention; and

FIG. 7 is a block diagram for describing a device for diagnosing a leak of a fuel system in a vehicle according to an exemplary embodiment of the present invention.

### DETAILED DESCRIPTION

In order to sufficiently understand an object achieved by the present invention and exemplary embodiments of the present invention, the accompanying drawings illustrating the exemplary embodiments of the present invention and contents disclosed in the accompanying drawings should be referred to.

Hereinafter, the present invention will be described in detail by describing exemplary embodiments of the present invention with reference to the accompanying drawings. In the description of the present invention, the detailed descriptions of known related constitutions or functions thereof may be omitted if they make the gist of the present invention unclear. Like reference numerals presented in respective drawings refer to like elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. In addition, it should be understood that term “include” indicates that a feature, a number, a step, an operation, a component, a part, or a combination thereof described in the specification is present, but does not exclude a possibility of presence or addition of one or more other features, numbers, steps, operations, components, parts, or combinations, in advance.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Throughout this specification and the claims that follow, when it is described that an element is “coupled” to another element, the element may be “directly coupled” to the other element or “electrically or mechanically coupled” to the other element through a third element. If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art, and are not to be interpreted as an ideally or excessively formal meaning unless clearly defined in the present specification.

A system for diagnosing a leak of a fuel system in a vehicle uses a method for monitoring the internal pressure of a fuel tank, and when the vehicle is driven, disturbance by vibration of the vehicle becomes a primary cause to incur a misdiagnosis. Accordingly, to improve monitoring reliability, in an example of the monitoring, the monitoring may be performed in an engine idle condition in which the vehicle stops. However, in recent years, in a vehicle adopting an idle stop & go function which is a technology for improving fuel efficiency, there has been a problem in performing the monitoring of the diagnosis method without the engine idle condition while stopping. The idle stop may mean a function in which an engine is automatically turned off when the vehicle stops and the engine automatically starts when a specific condition is satisfied.

Accordingly, a scheme such as a natural vacuum leakage detection (NVLD) system has been developed in the related art. However, the NVLD system may be more disadvantageous in terms of cost for diagnosing the leak of the fuel system than the method for monitoring the internal pressure of the fuel tank. The natural vacuum leak detection or naturally vacuum leak detection (NVLD) scheme used in a hybrid vehicle such as a hybrid electric vehicle is a scheme for diagnosing the leak of the fuel system when a start key of the vehicle is turned off, and since a fuel tank isolation valve fuel tank vapor isolation valve (FTIV) that closes or opens a connection passage between the fuel tank and a canister collecting evaporative gas of the fuel tank when the start key is turned off is in a normal closed state, leakage of the fuel tank part may be diagnosed.

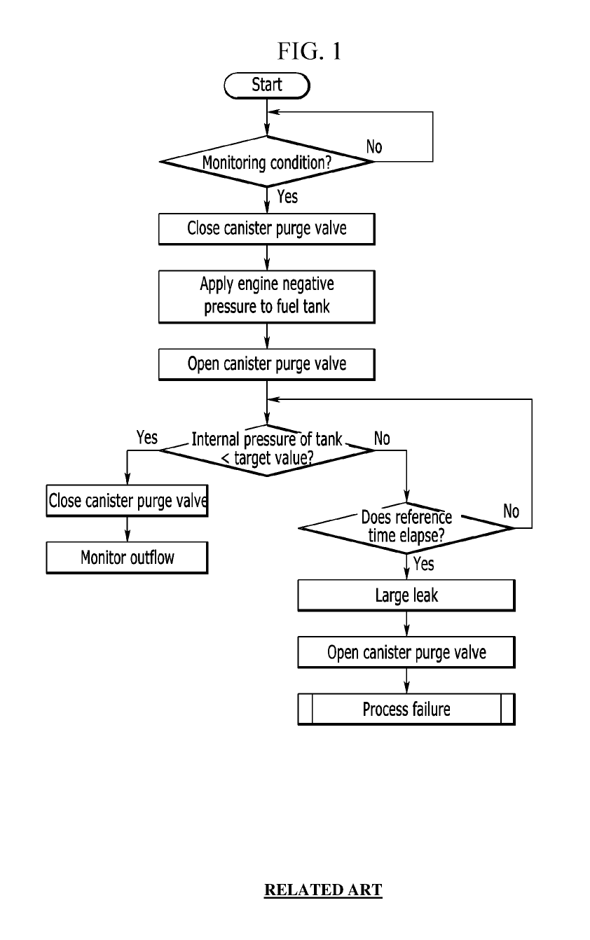

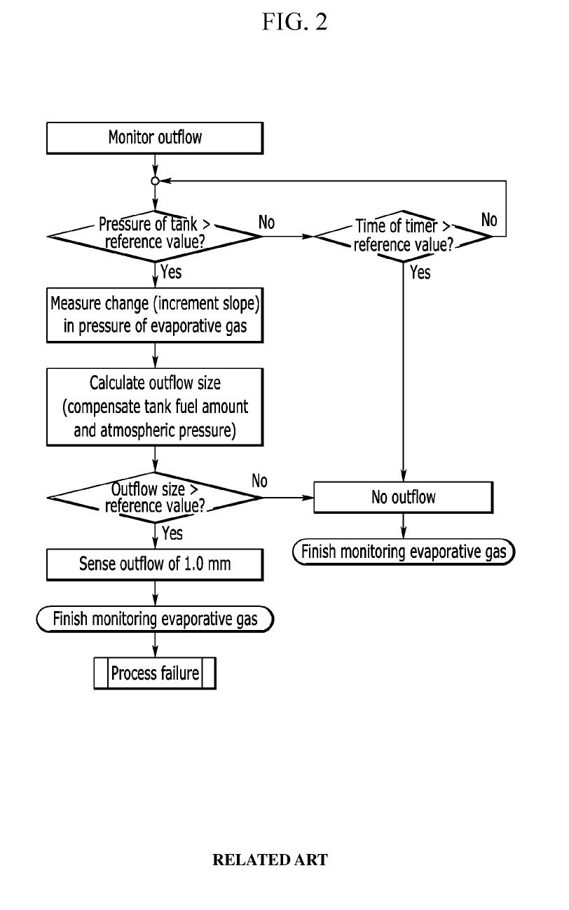

FIG. 1 is a flowchart illustrating an example of a method for diagnosing a leak of a fuel system according to the related art. In a monitoring condition for diagnosing the leak of the fuel system illustrated in FIG. 1, a vehicle speed is 0, and an engine is in an idle state and cooling water temperature and exterior temperature conditions of an engine may satisfy reference conditions. It may be difficult to apply the conditions in which the vehicle speed is 0 and the engine is in the idle state to a vehicle (e.g., a hybrid vehicle such as a hybrid electric vehicle having hybrid power) having an idle stop & go (ISG) function. When the monitoring condition is satisfied, the leak of the fuel system is diagnosed according to steps of the method for diagnosing the leak of the fuel system illustrated in FIG. 1. FIG. 2 is a flowchart illustrating the method for diagnosing the leak of the fuel system after a step (alternatively, an outflow monitoring starting step) of monitoring an outflow of FIG. 1 according to the related art.

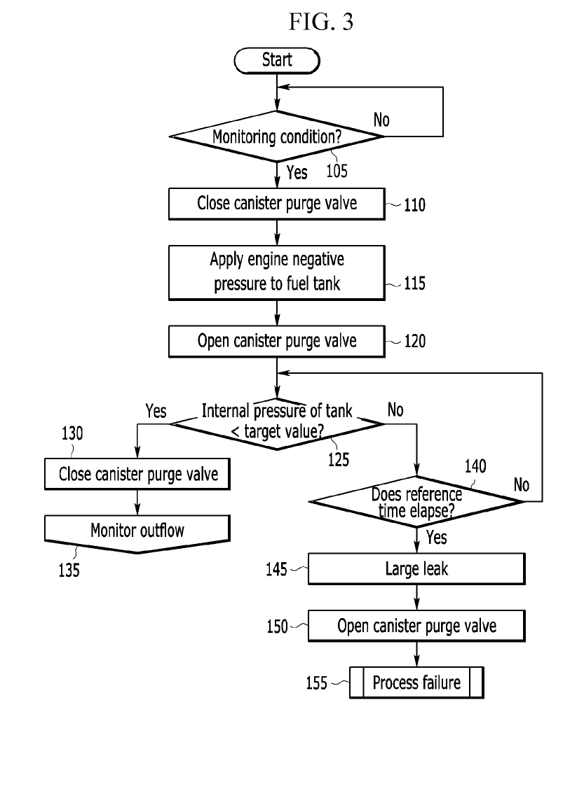

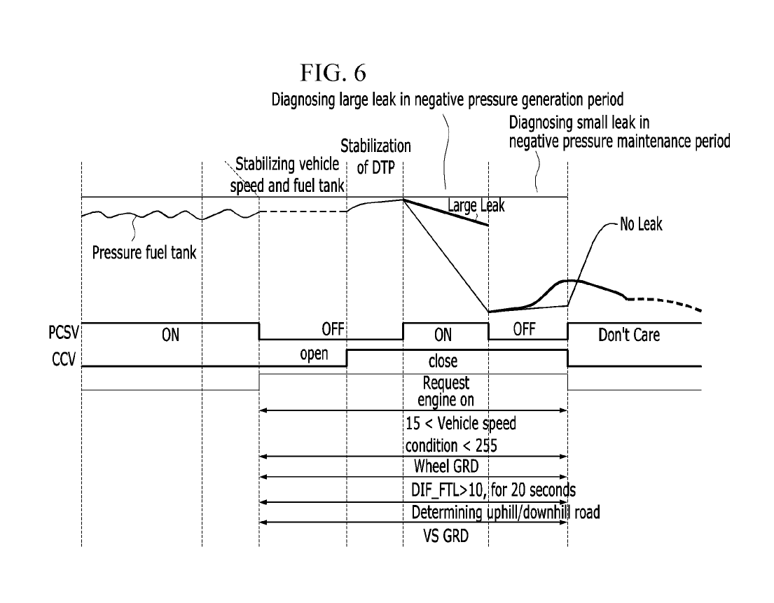

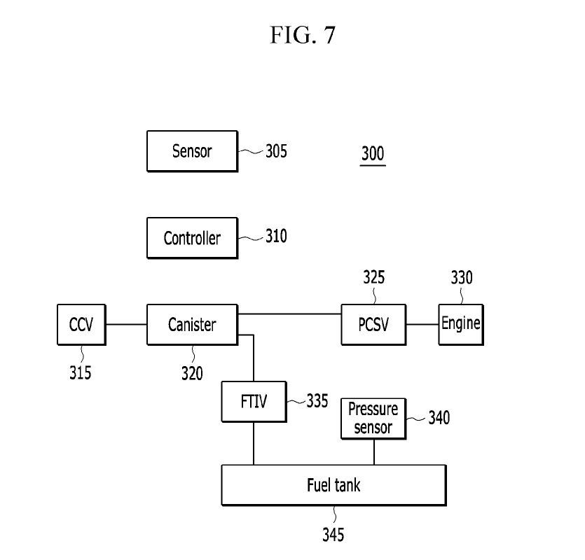

FIG. 3 is a flowchart illustrating a method for diagnosing a leak of a fuel system in a vehicle according to an exemplary embodiment of the present invention. FIG. 6 is a timing diagram for describing the method for diagnosing the leak of the fuel system in the vehicle, which is illustrated in FIGS. 3, 4, and 5. FIG. 7 is a block diagram for describing a device for diagnosing a leak of a fuel system in a vehicle according to an exemplary embodiment of the present invention. Referring to FIGS. 3, 6, and 7, in a condition determining step (105), a controller 310 may be configured to determine whether the monitoring condition (e.g., an entrance condition) of the method for diagnosing the leak of the fuel system is satisfied. The leak of the fuel system may include a leak of a pipe which is a flow path within the fuel system, a leak of a fuel tank 345, or a leak of a canister 320.

The monitoring condition for the method for diagnosing the leak of the fuel system may be a condition in which an engine 330 is actuated and the cooling water temperature and exterior temperature (e.g., air temperature) condition of an engine may be a condition to satisfy the reference condition (e.g., a condition in which the cooling water temperature is about 50 to 140° C. and the exterior temperature is about −8 to 35° C.). When additionally described, the controller 310 may be configured to determine whether the engine 330 is actuated and a vehicle 300 including the engine may thus be driven as the monitoring condition for diagnosing the leak of the fuel system. Accordingly, the present invention may be applied to the vehicle (e.g., a hybrid vehicle having hybrid power) having the ISG (idle stop & go) function. The hybrid vehicle may be actuated in an electric vehicle (EV) mode in which an engine clutch exists between a motor and an engine (e.g., a diesel engine) and the hybrid vehicle may be driven by the motor while the engine clutch is opened and in a hybrid electric vehicle (HEV) mode in which the hybrid vehicle may be driven by both the motor and the engine while the engine clutch is closed.

According to a closing step (110), in response to determining that the engine 330 is actuated and the vehicle 300 is thus driven, the controller 310 may be configured to operate a canister purge valve (alternatively, a purge control solenoid valve (PCSV) 325) to close or open a passage to connect the canister 320 and the engine 330 to be closed. When the canister purge valve 325 is closed, the controller 310 may be configured to operate a canister close valve (CCV) 315 that provides or interrupts the atmosphere (alternatively, air) outside the vehicle to be closed to allow the evaporative gas to be collected in the canister 320.

According to an applying step (115), when the canister purge valve (PCSV) 325 is closed, engine negative pressure to be applied to the fuel tank 345 may be formed in the engine 330. The engine negative pressure may be generated in an intake stroke. According to an opening step (120), when the engine negative pressure is formed in the engine 330, the controller 310 may be configured to open the canister purge valve (PCSV) 325 while the canister close valve (CCV) 315 is closed to apply the negative pressure of the engine 330 to the fuel tank 345.

According to a comparing step (125), the controller 310 may be configured to determine whether the internal pressure of the fuel tank, measured by a pressure sensor 340 attached (e.g., mounted) onto the fuel tank 345 and provided to the controller 310 is less than a target value (e.g., about −7 hPa). When the internal pressure of the fuel tank 345 is greater than the target value, the method for diagnosing the leak of the fuel system in the vehicle may proceed to a time elapse step (140), and when the internal pressure of the fuel tank is less than the target value, the process may proceed to the closing step (130).

According to the time elapse step (140), the controller 310 may be configured to determine whether a time during which the internal pressure of the fuel tank is greater than the target value is greater than a reference time (e.g., about 5 seconds) using a timer which may be included in the controller 310. When the time during which the internal pressure of the fuel tank 345 is greater than the target value is greater than the reference time, the process may proceed to an outflow determining step (145), and when the time during which the internal pressure of the fuel tank is greater than the target value is less than the reference time, the process may continue to the comparing step (125).

According to the outflow determining step (145), when the time during which the internal pressure of the fuel tank 345 is greater than the target value is greater than the reference time, the controller 310 may be configured to determine that the outflow of the evaporative gas of the fuel system is substantial (e.g., a substantial leak). According to the opening step (150), when the controller 310 determines that the outflow of the evaporative gas of the fuel system is substantial, the controller 310 may be configured to operate the canister purge valve 325 to be continuously opened. Then, fuel evaporative gas collected in the canister 320 may be provided to the engine 330.

According to a failure processing step (155), after the canister purge valve 325 is opened, the controller 310 may be configured to output a signal (e.g., information) indicating that a failure occurs in the fuel system to a display unit which may be mounted in a center fascia of the vehicle. According to the closing step (130), the controller 310 may be configured to close the canister purge valve (PCSV) 325 while the canister close valve (CCV) 315 is closed. According to an outflow monitoring step (135), after the canister purge valve (PCSV) 325 is closed, the controller 310 may be configured to start monitoring the outflow of the fuel system.

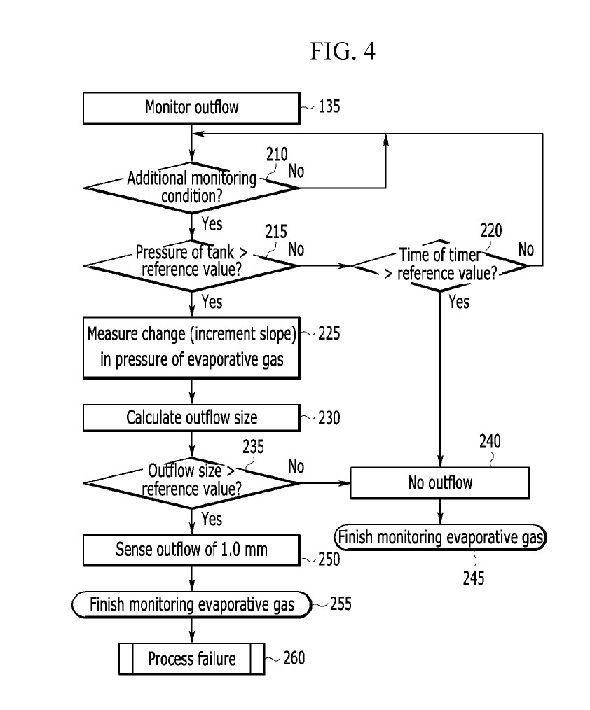

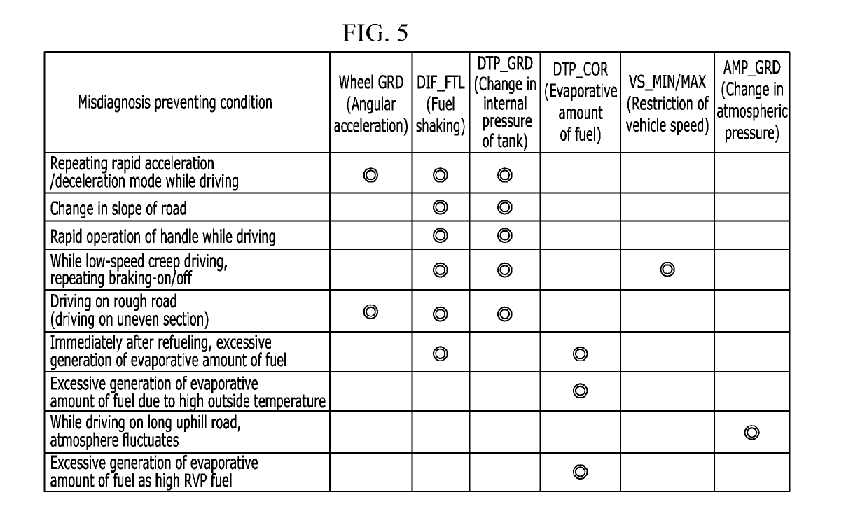

FIG. 4 is a flowchart illustrating the method for diagnosing the leak of the fuel system in the vehicle after a step (e.g., an outflow monitoring starting step) of monitoring an outflow of FIG. 3. Referring to FIGS. 4, 6, and 7, in an additional monitoring condition determining step (210), the controller 310 may be configured to determine whether an additional monitoring condition of the method for diagnosing the leak of the fuel system is satisfied. The additional monitoring condition may be a condition for preventing misdiagnosis by disturbance while driving or a condition for preventing misdiagnosis of the pressure (e.g., the leak of the fuel system) of the evaporative gas of the fuel tank. FIG. 5 is a table for describing the additional monitoring condition illustrated in FIG. 4. Referring to FIG. 5, a driving condition for preventing the misdiagnosis of the leak of the fuel system which is the additional monitoring condition will be described below.

The additional monitoring condition may include a driving condition of the vehicle, which does not correspond to a condition in which a rapid acceleration mode and a rapid deceleration mode while driving are repeated. The condition in which the rapid acceleration mode and the rapid deceleration mode are repeated may change an angular acceleration of a driving wheel of the vehicle, cause fuel shaking (e.g., sloshing) of the fuel tank 345, and change the internal pressure of the fuel tank.

The additional monitoring condition may include a driving condition of the vehicle which does not correspond to a condition in which the vehicle is driven on a road having a varied slope. The condition in which the vehicle is driven on the road having the varied slope may cause the fuel shaking of the fuel tank and change the internal pressure of the fuel tank. Further, the additional monitoring condition may include a driving condition of the vehicle which does not correspond to a driving condition based on a rapid operation of a steering wheel (or a handle) of the vehicle. The driving condition based on the rapid operation of the steering wheel of the vehicle may cause the fuel shaking of the fuel tank and change the internal pressure of the fuel tank.

The additional monitoring condition may include a driving condition which does not correspond to a condition in which brake-on and off (e.g., disengagement and engagement of brake pedal) of the vehicle are repeated while the vehicle creeps at a substantially low speed. The condition in which the brake-on and off are repeated while the vehicle creeps at the low speed may be a condition which causes the fuel shaking of the fuel tank, changes the internal pressure of the fuel tank, and corresponds to restriction of the vehicle speed. The additional monitoring condition may include a driving condition which does not correspond to a condition in which the vehicle is driven on a rough road having an uneven section (e.g., an uneven surface on a section of the road). The condition in which the vehicle is driven on the rough road having the uneven section may change the angular acceleration of the driving wheel of the vehicle, cause the fuel shaking of the fuel tank, and change the internal pressure of the fuel tank.

Furthermore, the additional monitoring condition may include a driving condition which does not correspond to a condition in which a fuel evaporative amount of the vehicle is excessively generated as a condition after refueling. The condition after the refueling of the vehicle may cause the fuel shaking of the fuel tank and excessively generate the fuel evaporative amount of the fuel tank. The additional monitoring condition may include a driving condition which does not correspond to the condition in which the fuel evaporative amount is excessively generated as a condition in which the exterior temperature of the vehicle is high (e.g., greater than a predetermined temperature). The condition in which the exterior temperature of the vehicle is high may excessively generate the fuel evaporative amount of the fuel tank.

The additional monitoring condition as a condition in which the vehicle is driven on an uphill road or a downhill road may include a driving condition which does not correspond to a condition in which atmospheric pressure fluctuates. The additional monitoring condition may include a driving condition which does not correspond to the condition in which the fuel evaporative amount is excessively generated as a condition in which the vehicle is driven with fuel having high Reid vapor pressure (RVP). In other exemplary embodiments of the present invention, the additional monitoring condition determining step (210) may be performed after the condition determining step (105).

Referring back to FIGS. 4, 6, and 7, in a comparing step (215), the controller 310 may be configured to determine whether the internal pressure of the fuel tank, measured by the pressure sensor 340 which may be attached (e.g., mounted) onto the fuel tank 345 and provided to the controller 310, is greater than a reference value (e.g., about −22 hPa). When the internal pressure of the fuel tank 345 is less than the reference value, the process may proceed to the comparing step (220), and when the internal pressure of the fuel tank is greater than the reference value, the process may proceed to a measuring step (225).

According to the comparing step (220), the controller 310 may be configured to measure a time during which the internal pressure of the fuel tank is less than the reference value using the timer which may be included in the controller 310 and determine whether the time of the timer is greater than the reference value (e.g., about 5 seconds). When the time of the timer is less than the reference value, the process may proceed to the additional monitoring condition determining step (210), and when the time of the timer is greater than the reference value, the process may proceed to a no-leak determining step (240).

According to the no-leak determining step (240), since the internal pressure of the fuel tank is less than the reference value, the controller 310 may be configured to determine that the leak of the evaporative gas of the fuel system does not occur and provide a signal (information) indicating that the leak does not occur to the display unit. According to an end step (245), after outputting the signal (e.g., information) indicating that the leak does not occur, the controller 310 may then be configured to complete the method for monitoring the leak of the evaporative gas which is the method for diagnosing the leak of the fuel system.

According to the measuring step (225), the pressure sensor 340 which may be operated by the controller 310 may be configured to measure an increment slope which is a change in pressure of the evaporative gas in the fuel tank 345. According to a calculating step (230), the controller 310 may be configured to calculate the size of a leak (e.g., a caliber size (diameter) of a leak aperture) of the fuel system by using the increment slope. According to the comparing step (235), after the leak size is calculated, the controller 310 may be configured to determine whether the calculated leak size is greater than a reference value (e.g., about 0.5 mm) When the leak size is less than the reference value, the process may proceed to the no-leak determining step (240), and when the leak size is greater than the reference value, the process may proceed to a sensing step (250).

According to the sensing step (250), the controller 310 may be configured to sense (e.g., determine) a leak of about 1.0 mm when the leak size is greater than the reference value and output the signal indicating that the leak occurs to the display unit. The leak of about 1.0 mm may indicate a minimal leak of the evaporative gas in the fuel system. According to the end step (255), after outputting the signal indicating that the leak occurs, the controller 310 may be configured to complete the method for monitoring the leak of the evaporative gas which is the method for diagnosing the leak of the fuel system. According to the failure processing step (260), after the method for monitoring the leak of the evaporative gas ends, the controller 310 may be configured to output a signal indicating that the failure occurs in the fuel system to the display unit.

FIG. 6 is a timing diagram describing a method for diagnosing a leak of the fuel system in the vehicle illustrated in FIGS. 3, 4, and 5. Referring to FIGS. 6 and 7, during a pressure variation period, the PCSV 325 is opened (ON), the CCV 315 may be opened, and internal pressure (e.g., differential tank pressure (DTP)) of the fuel tank 345 may be varied. During a stabilization period of a vehicle speed and the fuel tank, the PCSV 325 is closed (OFF), the CCV 315 may be continuously opened, the vehicle speed may be stabilized, and the pressure of the fuel tank 345 may be stabilized. During a stabilization period of the DTP of the fuel tank, the PCSV 325 is continuously closed (OFF), the CCV 315 may be closed, and the DTP of the fuel tank may be further stabilized.

During a negative pressure formation period, the PCSV 325 is opened (ON), the CCV 315 may be continuously closed, and when the slope of the internal pressure of the fuel tank is minimal (alternatively, when the slope is less than a particular slope degree), the controller 310 may be configured to determine a substantial leak of evaporative gas in the fuel system. When the slope of the internal pressure of the fuel tank is steep (e.g., the slope is substantial or greater than a predetermined slope), the controller 310 may be configured to determine no leak of the evaporative gas in the fuel system. During a period between a start time point of the stabilization period of the vehicle speed and the fuel tank and an end time point of a negative pressure maintenance period, the controller 310 may be configured to operate the engine 330.

During the negative pressure maintenance period, the PCSV 325 is closed, the CCV 315 may be continuously closed, and as illustrated in FIG. 6, when there is a change in slope of the internal pressure of the fuel tank, the controller 310 may be configured to determine a minimal leak of the evaporative gas in the fuel system. When there is a minimal change in slope of the internal pressure of the fuel tank, the controller 310 may be configured to determine no leak of the evaporative gas in the fuel system.

The method for diagnosing a leak of the fuel system in the vehicle illustrated in FIG. 6 may be applied to a hybrid vehicle such as a hybrid electric vehicle (HEV). During the period between the start time point of the stabilization period of the vehicle speed and the fuel tank and the end time point of the negative pressure maintenance period, the vehicle speed may satisfy a condition of, for example, e.g., 15 kph (kilometers per hour) <vehicle speed condition <255 kph.

During the period between the start time point of the stabilization period of the vehicle speed and the fuel tank and the end time point of the negative pressure maintenance period, a change of angular acceleration of the wheel (e.g., wheel gradient (GRD)) may be determined. The controller 310 may be configured to terminate leak diagnosis control of the fuel system when fuel shake of the fuel system exceeds about 10 times for about 20 seconds.

During the period between the start time point of the stabilization period of the vehicle speed and the fuel tank and the end time point of the negative pressure maintenance period, the controller 310 may be configured to determine whether to drive the vehicle on an uphill road or a downhill road using an acceleration signal transmitted from the acceleration sensor, and may be configured to terminate the leak diagnosis control of the fuel system when the vehicle is driven on the uphill road or the downhill road for a predetermined amount of time (e.g., a predetermined distance). During the period between the start time point of the stabilization period of the vehicle speed and the fuel tank and the end time point of the negative pressure maintenance period, the controller 310 may be configured to sense whether the vehicle is driven by operating the engine by determining a vehicle speed gradient (VS GRD).

FIG. 7 is a block diagram describing a device for diagnosing a leak of the fuel system in the vehicle according to the exemplary embodiment of the present invention. The method for diagnosing the leak of the fuel system in the vehicle according to the exemplary embodiment of the present invention may be applied to the device for diagnosing the leak of the fuel system in the vehicle. Referring to FIG. 7, a vehicle 300 including the device for diagnosing the leak of the fuel system in the vehicle may include a sensor 305, a controller 310, a canister close valve (CCV) 315, a canister 320, a canister purge valve (PCSV) 325, an engine 330, a fuel tank isolation valve (FTIV) 335, a pressure sensor 340, and a fuel tank 345. The controller 310 may be configured to operate the various components of the system.

The CCV 315 (e.g., a canister interruption valve) may be configured to provide or interrupt external air of the vehicle to the canister 320. In particular, the CCV 315 may be configured to open and close an air passage by which the external air flows into the canister 320. The PCSV 325 may be configured to close or open a pipe (e.g., a pipeline) which is a passage capable of connecting the canister 320 and the engine 330. The FTIV 335 may be configured to close or open the pipe which may be the passage capable of connecting the canister 320 and the fuel tank 345. When the method for diagnosing the leak of the fuel system in the vehicle according to the exemplary embodiment of the present invention is performed, the FTIV 335 may be opened. The pressure sensor 340 may be configured to sense (e.g., measure or detect) internal pressure of the fuel tank 345.

The device for diagnosing the leak of the fuel system in the vehicle may include the sensor 305 and the controller 310. The vehicle fuel system may include the CCV 315, the canister 320, the PCSV 325, the FTIV 335, the pressure sensor 340, and the fuel tank 345. In another exemplary embodiment of the present invention, the FTIV 335 may be omitted, and the canister 320 and the fuel tank 345 may be directly connected to each other via the pipe. The sensor 305 may include an engine operation sensor such as an ignition switch sensor, a vehicle speed sensor such as a driving sensor, an acceleration sensor, and the like. The sensor 305 may be configured to output a driving signal by sensing whether the engine 330 is actuated and the vehicle 300 may thus be driven as a monitoring condition for diagnosing the leak of the fuel system.

The controller 310 may be configured to determine that the monitoring condition is satisfied based on the driving signal transmitted from the sensor 305, and may be configured to determine whether an additional monitoring condition for monitoring an outflow of the fuel system is satisfied in response to determining that the monitoring condition is satisfied and the internal pressure of the fuel tank 345 included in the fuel system is less than a target value. The additional monitoring condition may be a condition preventing misdiagnosis of the leak in the fuel system due to disturbance while the vehicle 300 is driven. A sensing signal for the additional monitoring condition (e.g., detecting of the additional monitoring condition) may be detected by a plurality of sensor units (e.g., an acceleration sensor and the like) included in the sensor 305, and the sensing signal may be provided by the controller 310.

The controller 310 may include an engine control unit (ECU) configured to operate the engine 330. The controller 310 may be, for example, one or more microprocessors or hardware including the microprocessors which operate by a program, and the program may include a series of commands for performing the aforementioned method for diagnosing the leak of the fuel system in the vehicle according to the exemplary embodiment of the present invention. The controller 310 may perform a function of a central processing unit (CPU) (alternatively, a processor) and execute the overall operation of the sensor 305, the CCV 315, the PCSV 325, the engine 330, the FTIV 335, the pressure sensor 340, and the like.

The additional monitoring condition may be a condition in which the vehicle 300 repeats a rapid acceleration mode and a rapid deceleration mode while driving, a condition in which the vehicle 300 is driven on a road having a varied slope, or a driving condition which does not correspond to the driving condition according to a rapid steering wheel operation of the vehicle 300. The additional monitoring condition may be a condition in which the vehicle 300 repeats braking on and off while low-speed creep driving, a condition in which the vehicle 300 is driven on an uneven section, or a driving condition which does not correspond to a condition after the vehicle 300 is refueled.

The additional monitoring condition may be a condition in which an outside temperature of the vehicle 300 is greater than a first reference value (e.g., about 35° C.) and less than a second reference value (e.g., about 60° C.), a condition in which the vehicle 300 is driven on an uphill road or a downhill road, or a driving condition which does not correspond to a condition in which the vehicle 300 is driven with fuel having high vapor pressure.

The controller 310 may be configured to operate the PCSV 325 to open or close a passage connecting the canister 320 which collects evaporative gas (e.g., fuel evaporative gas) of the fuel tank and the engine 330 to be opened before determining whether the internal pressure of the fuel tank 345 is less than the target value, and operate the CCV 315 to provide or interrupt the external air of the vehicle 300 to or from the canister 320 to be closed to apply the negative pressure of the engine 330 to the fuel tank 345. When the controller 310 determines the outflow of the fuel system, the controller 310 may be configured to close the PCSV 325 and close the CCV 315.

As described above, the present invention may be applied to the vehicle having the ISG function as a technology that enhances a misdiagnosis problem which may occur while driving using the method for monitoring the internal pressure of the fuel tank. Accordingly, the vehicle may cope (deal) with on-board diagnostics (OBD) reinforcement regulations (e.g., OBD regulations or vehicle discharge gas regulations) which are progressed.

In the present invention, since a gasoline vehicle may use leak diagnosis hardware (H/W) of the fuel system, cost for the diagnosis may increase. Further, the present invention may prevent the cost from being increased when the NVLD system is applied. In the present invention, since there is no separate engine starting request for the diagnosis, the fuel efficiency of the vehicle may be enhanced and a real road OBD diagnostic rate may be enhanced.

In addition, since a valve actuation sound is less than noise generated when the vehicle is driven, valve actuation noise generated while performing the diagnosis may be reduced. Further, the present invention may include a logic (control logic) required to satisfy the OBD (IUPRm) regulations (e.g., the OBD regulations including IUPRm) in the ISG-applied vehicle (e.g., the vehicle having the ISG function).

As described above, the exemplary embodiments are disclosed in the drawings and the specification. Herein, specific terms are used, but the specific terms are just used for describing the present invention and are not used to limit a meaning or limit the scope of the present invention disclosed in the claims. Therefore, it will be appreciated by those skilled in the art that various modifications may be made and equivalent embodiments are available based on the present invention. Accordingly, the true technical scope of the present invention should be defined by the technical spirit of the appended claims.

### DESCRIPTION OF SYMBOLS

305: Sensor

310: Controller

315: CCV

320: Canister

325: PCSV

340: Pressure sensor

345: Fuel tank

What is claimed is:

1. A method for diagnosing a leak of a fuel system in a vehicle, comprising:
determining, by a controller, whether an engine is actuated and a vehicle is thus driven as a monitoring condition for diagnosing the leak of the fuel system; and
determining, by the controller, whether an additional monitoring condition for monitoring an outflow of the fuel system is satisfied in response to determining that the engine is actuated and an internal pressure of a fuel tank included in the fuel system is less than a target value,
wherein the additional monitoring condition is a condition of preventing misdiagnosis of the leak in the fuel system due to disturbance while the vehicle is driven.

2. The method of claim 1, wherein the additional monitoring condition is a driving condition which does not correspond to a condition in which a rapid acceleration mode and a rapid deceleration mode of the vehicle while driving are repeated, a condition in which the vehicle is driven on a road having a varied slope, or a driving condition depending on a rapid operation of a steering wheel of the vehicle.

3. The method of claim 1, wherein the additional monitoring condition is a condition in which the vehicle repeats braking on and off while creep driving, a condition in which the vehicle is driven on an uneven section, or a driving condition which does not correspond to a condition after the vehicle is refueled.

4. The method of claim 1, wherein the additional monitoring condition is a driving condition which does not correspond to a condition in which an exterior temperature of the vehicle is greater than a predetermined temperature, a condition in which the vehicle is driven on an uphill road or a downhill road, or a condition in which the vehicle is driven with fuel having high vapor pressure.

5. The method of claim 1, wherein before the controller determines whether the internal pressure of the fuel tank is less than the target value, the controller is configured to operate a canister purge valve to open or close a passage connecting a canister collecting evaporative gas of the fuel tank and the engine to be opened and operate a canister close valve to provide or interrupt the atmosphere exterior to the vehicle to or from a canister to be closed to apply negative pressure of the engine to the fuel tank.

6. The method of claim 6, wherein when the controller determines the outflow of the fuel system, the controller is configured to close the canister purge valve and close the canister close valve.

7. A device for diagnosing a leak of a fuel system in a vehicle, comprising:
a sensor configured to generate a driving signal by sensing whether an engine is actuated and a vehicle is thus driven as a monitoring condition for diagnosing the leak of the fuel system; and
a controller configured to determine that the monitoring condition is satisfied based on the driving signal transmitted from the sensor and determine whether an additional monitoring condition for monitoring an outflow of the fuel system is satisfied in response to determining that the monitoring condition is satisfied and an internal pressure of the fuel tank included in the fuel system is less than a target value,
wherein the additional monitoring condition is a condition of preventing misdiagnosis of the leak in the fuel system due to disturbance while the vehicle is driven.

8. The device of claim 7, wherein the additional monitoring condition is a driving condition which does not correspond to a condition in which a rapid acceleration mode and a rapid deceleration mode of the vehicle while driving are repeated, a condition in which the vehicle is driven on a road having a varied slope, or a driving condition depending on a rapid operation of a steering wheel of the vehicle.

9. The device of claim 7, wherein the additional monitoring condition is a condition in which the vehicle repeats braking on and off while creep driving, a condition in which the vehicle is driven on an uneven section, or a driving condition which does not correspond to a condition after the vehicle is refueled.

10. The device of claim 7, wherein the additional monitoring condition is a driving condition which does not correspond to a condition in which an exterior temperature of the vehicle is greater than a predetermined temperature, a condition in which the vehicle is driven on an uphill road or a downhill road, or a condition in which the vehicle is driven with fuel having high Reid vapor pressure.

11. The device of claim 7, wherein before the controller determines whether the internal pressure of the fuel tank is less than the target value, the controller is configured to operate a canister purge valve to open or close a passage connecting a canister collecting evaporative gas of the fuel tank and the engine to be opened and operate a canister close valve to provide or interrupt the atmosphere exterior to the vehicle to or from the canister to be closed to apply negative pressure of the engine to the fuel tank.

12. The device of claim 11, wherein when the controller is configured to determine the outflow of the fuel system, close the canister purge valve, and close the canister close valve.

13. A non-transitory computer readable medium containing program instructions executed by a controller, the computer readable medium comprising:
program instructions that control a sensor to generate a driving signal by sensing whether an engine is actuated and a vehicle is thus driven as a monitoring condition for diagnosing a leak of a fuel system; and
program instructions that determine that the monitoring condition is satisfied based on the driving signal transmitted from the sensor and determine whether an additional monitoring condition for monitoring an outflow of the fuel system is satisfied in response to determining that the monitoring condition is satisfied and an internal pressure of the fuel tank included in the fuel system is less than a target value,
wherein the additional monitoring condition is a condition of preventing misdiagnosis of the leak in the fuel system due to disturbance while the vehicle is driven.

14. The non-transitory computer readable medium of claim 13, wherein the additional monitoring condition is a driving condition which does not correspond to a condition in which a rapid acceleration mode and a rapid deceleration mode of the vehicle while driving are repeated, a condition in which the vehicle is driven on a road having a varied slope, or a driving condition depending on a rapid operation of a steering wheel of the vehicle.

15. The non-transitory computer readable medium of claim 13, wherein the additional monitoring condition is a condition in which the vehicle repeats braking on and off while creep driving, a condition in which the vehicle is driven on an uneven section, or a driving condition which does not correspond to a condition after the vehicle is refueled.

16. The non-transitory computer readable medium of claim 13, wherein the additional monitoring condition is a driving condition which does not correspond to a condition in which an exterior temperature of the vehicle is greater than a predetermined temperature, a condition in which the vehicle is driven on an uphill road or a downhill road, or a condition in which the vehicle is driven with fuel having high Reid vapor pressure.

17. The non-transitory computer readable medium of claim 13, wherein before the determination of whether the internal pressure of the fuel tank is less than the target value, the computer readable medium further comprise program instructions that operate a canister purge valve to open or close a passage connecting a canister collecting evaporative gas of the fuel tank and the engine to be opened and operate a canister close valve to provide or interrupt the atmosphere exterior to the vehicle to or from the canister to be closed to apply negative pressure of the engine to the fuel tank.

18. The non-transitory computer readable medium of claim 17, further comprising program instructions that determine the outflow of the fuel system, close the canister purge valve, and close the canister close valve.
